(19) United States
(12) Patent Application Publication
(10) Pub. No.: US 2010/0055374 A1
(43) Pub. Date: Mar. 4, 2010

(54) Retroflective pavement markers for wet weather

(76) Inventors: Robert W. Greer, Lexington, NC (US); Simon Yakopson, Hickory, NC (US)

Correspondence Address: GUERRY LEONARD GRUNE, 784 S VILLIER CT., VIRGINIA BEACH, VA, 23452, US

(21) Appl. No.: 12/231,406

(22) Filed: Sep. 2, 2008

(51) Int. Cl. B32B 5/16; C08K 3/22; C08K 3/36; B32B 3/12

(52) U.S. Cl. 428/64.1; 428/220; 524/502; 524/539; 524/430; 524/433; 524/432; 524/413; 428/147; 428/116; 428/80

(57) ABSTRACT

Disclosed is a bi-composition preformed thermoplastic pavement marking material having a first composition of thermoplastic material with specified melting temperature in the range of 90° to 120° C. and a second composition of thermoplastic material having desired profiles with a specified melt temperature of 10° C.-70° C. higher than the first composition wherein preformed thermoplastic pavement marking has embedded reflective elements and where the first composition melts at an observably lower temperature than the second composition preventing overheating of the second composition and providing good bond to pavement.

### FIELD OF DISCLOSURE

The present disclosure relates to retroreflective preformed thermoplastic pavement marking (PTPM) materials that retain a desired pattern after heating and exhibit good retroreflective brightness especially during wet night time driving.

### BACKGROUND OF DISCLOSURE

Pavement markings, such as those on the centerline and edgeline of a roadway, are important in order to provide visual guidance for motor vehicle drivers. Pavement marking materials are used as traffic control markings for a variety of uses, such as short distance lane striping, stop bars, and pedestrian pavement markings at intersections and long line lane markings, etc. on roadways. A common form of pavement marking material is adhesive-backed tape that is applied to the roadway surface in desired location and length; the top surface of the tape having selected color and typically retroreflective characteristics. The common denominator in all these materials and/or methods is that they are useful in areas where there is little or no wear.

Currently, many flat, or low profile, pavement markings typically rely on an exposed-lens optical system having transparent microspheres partially embedded in a binder layer containing reflective pigment particles such as titanium dioxide or lead chromate When the light from a vehicle's headlight enters the microsphere it is refracted to fall on the reflective pigment. A portion of the light is returned generally along the original entrance path toward the vehicle so as to be visible to the driver. The amount of refraction and the amount of light gathering of these microspheres is dependent in part upon maintaining a low index of refraction air interface on the exposed portion of the microsphere. During rainy periods, the microspheres become wet reducing their light refracting ability and resulting in much reduced retroreflective performance.

The present day low profile pavement markings provide effective retroreflective response for only a narrow range of entrance angles than is sometimes desired. For example, flat pavement markings, relying on microspheres partially embedded in layers containing diffuse pigments as described above, are most easily seen at distances of approximately 80 meters and less. This gives the driver approximately 3 seconds to respond while driving at 60 MPH. At speeds higher than this the time is reduced and in particular at distances greater than this, retroreflective brightness declines due in part to the relatively larger entrance angles of the incident light and in part to inherently limited retroreflective brightness. In addition to generally low retroreflectivity at high incidence angles, flat pavement markings are particularly difficult to see under rainy conditions for the reasons discussed above.

Another type of pavement marking known as “raised pavement markings” typically have better wet reflectivity because the rain will run off the raised portions and they sometimes use reflective systems that are inherently retroreflective when wet. Many of these are individual markings that have a height of one-half inch or more. However, snow removal is frequently a problem on roads bearing raised pavement markings, as the snowplows have a tendency to catch on the raised protrusions and dislodge the markings from the road surface. Also, raised pavement markings mounted as spot delineators provide relatively poor daytime-road delineation and thus commonly need to be augmented with continuous painted or tape line markings.

A problem with plastic pavement marker strips of the prior art is that of providing satisfactory adherence to the road surface under the constant use of motor vehicle traffic. The pavement marker must deform readily and flow without memory into the irregular surface contours of the pavement. The deformability and ability to cold flow permits the absorption of the energy of vehicle tire impacts which would otherwise violently dislodge the pavement marker as the impact energy is dissipated. Pavement markings applied with heat directly to the pavement surface have been shown to resist wear in heavy traffic areas such as stop bars, turn lanes and in-lane signage.

What is needed is a reflective preformed thermoplastic marking material with a slightly raised surface pattern comprising a material that has a melt temperature that is greater than 10 degrees Celsius higher than the base thermoplastic material so that the base material may be melted into the surface of the pavement and the pattern remains raised to provide better reflectivity at higher incidence angles than a flat surface, low incidence angle tape or stripe. The preformed thermoplastic pavement marking (PTPM) with the raised surface pattern is may be less than 0.250″ thereby avoiding damage by snowplows yet thick enough with proper adhesion to withstand high vehicle traffic areas.

### RELEVANT ART

U.S. Pat. No. 6,960,989, to Grayson, Thomas, and unassigned, describes a detectable warning method for providing a tactile warning upon a pavement surface, using a mold having a top surface and a plurality of dome creation cavities extending downwardly from the top surface. The dome creation cavities are spaced apart from each other in a grid, and having the steps of covering the top surface of the mold with a first sheet of thermoplastic material, coating the top surface and the mold and the dome creation cavities with a conforming continuous top layer of thermoplastic material by applying heat to the first sheet of thermoplastic material, creating a plurality of detectable warning domes by filling the dome creation cavities with a heat resistant material and creating a detectable warning carrier assembly by coating the detectable warning domes and top layer with a base layer of thermoplastic by fully covering the base layer and detectable warning domes with a second sheet of thermoplastic material and applying heat to the second sheet of thermoplastic material and applying the base layer to the pavement surface.

U.S. Pat. No. 7,142,095, to Grayson, Thomas, and unassigned, describes a detectable warning system for installation onto a pavement surface adjacent to a hazardous transition, having an attachment layer made up of one of a base layer and a top layer. The attachment layer is substantially planar and made of thermoplastic material, a plurality of domes made of a heat resistant material, the domes secured to the attachment layer and arranged in a grid thereupon, the carrier layer extending substantially planar between the domes, such that the attachment layer may be adhered to a pavement surface by applying heat thereto and the heat resistant material of the domes is unaffected by heat.

U.S. Pat. No. 6,833,434, to Kang, Sung Soon, and assigned to Samki Entech Co. Ltd., describes noctilucent polyurethane chips prepared by the process of collecting waste polyurethane scraps and separating the scraps according to their colors, pulverizing the waste polyurethane scraps in a predetermined size, mixing 2-5 kg of stearic acid, 1 -10 kg of a photoluminescent pigment, 1-3 kg of a flame retardant, 0.1-1 kg of titanium dioxide and 10-30 kg of heavy calcium carbonate based on 100 kg of the pulverized waste polyurethane scraps, extruding the mixture through an extruder and cutting the extruded polyurethane in particle diameter of 3-10 mm.

U.S. Pat. No. 5,087,148, to Wyckoff, Charles W., and assigned to Brite Line Corp., describes a roadway marker strip for adhesive attachment along a bottom surface of the strip to a roadway having a rubber-like sheet with a bottom layer and surface which possess cold-flow substantially memory-free characteristics and an upper layer and surface deformed into successive protuberances such as ridges and wedges from which incident light from a vehicle traveling along the roadway may be reflected or retro-reflected to indicate a roadway direction. The deformed upper layer and surface including the protuberances are cross-link-vulcanized so as to possess substantial memory enabling restoration of depression of the protuberances caused by vehicle.

U.S. Pat. No. 3,954,346, to Miller, George W., and unassigned, describes a safety strip and a combination length of a wear-resistant white rubber strip securable to a pavement or roadway by a rubber-based cement, a means for easily seeing the strip at night and particularly on rainy nights the strip has a cross-sectionally upwardly rounded upper surface. The means has a series of multi-faceted, diamond-shaped glass reflectors protruding upwardly from the upper surface of the strip, with the reflectors being anchored in the strip by lengths of rods and each reflector incorporating a downward extending stem, each stem having a transverse opening therethrough receiving the rod, and the rods extending along a longitudinal direction of the strip.

U.S. Pat. No. 3,392,639, to Heenan, et. al., and assigned to Elastic Stop Nut Corp. of America, describes a pavement marker for providing a marking on a generally horizontal roadway surface, the marking being visible from an oncoming vehicle on the roadway both during the day and during the night, said pavement marker having a body of synthetic resin having at least one portion providing a face located in a position to be viewed from the oncoming vehicle, the body portion having a first part which is opaque, the first part providing a first facial portion capable of being effectively viewed in daylight and a second part which is light transmitting and has an outer, obverse light receiving and refracting surface, and inner, reverse light receiving and reflecting surface and a retro-directive reflecting system in the reverse surface for receiving light from emanating from the oncoming vehicle and incident upon the obverse face and reflecting such light generally parallel to the angle of incidence for rendering the second part reflective and providing a second facial portion capable of being effectively viewed at night. Each of the first and second facial portions are oriented as to make an acute angle with the horizontal and to rise above the roadway surface upon which the pavement marker is to be installed, each acute angle is great enough to reduce deterioration of the first and second facial portions arising out of contact with the oncoming vehicle while being small enough to allow adequate wiping of the first and second facial portions by such contact with the acute angle of the first facial portion being great enough to provide a sufficiently large projected viewable area and the acute angle of the second facial portion being great enough to maintain adequate optical effectiveness of the retro-directive reflective system during service.

U.S. Pat. No. 5,340,652, to Sondhe, et. al., and unassigned, describes an article having a cured epoxy layer and a cured urethane layer in contact with and intermingled with the epoxy layer. The epoxy layer is derived from a mixture of a two-part liquid epoxy coating composition having an epoxy resin part and a part of at least one epoxy hardener and containing less than 10 weight percent volatiles. The epoxy layer is cured at ambient temperature or higher and having an equivalent ratio of the hardener to the epoxy resin of from 0.75 to 1.05 the urethane layer derived from the reaction mixture of a two-part urethane composition having a first part of an intermediate component having at least one polyol intermediate and optionally a moisture scavenger and a second part having a polyisocyanate component. The urethane layer is cured at ambient temperature or higher and contains less than 10 wt. % volatiles.

U.S. Pat. No. 6,247,872, to Mercato, Forrest C., and assigned to The Rainline Corp., describes an apparatus for applying a traffic stripe to a road surface having at least one vehicle, a first applicator operatively attached to the vehicle for applying a traffic stripe material to the road surface, the applicator including a first member securable in a first position for allowing the material to be road surface and in a second position for preventing the material from exiting the applicator. There is a second member capable of being adjustably positioned such that it forms the stripe with at least one portion having a first height and at least one portion having a second height, the second height being greater than the first height, a second applicator for applying a reflective material to the traffic stripe and a deformation member spaced from the first applicator and a lifting mechanism that raises the deformation member at predetermined intervals such that the deformation member forms a profile in at least one portion of the stripe having a first height and in at least one portion of the stripe having a second height such that the second height remains greater than the first height.

U.S. Pat. No. 6,479,132, to Hedblom, et. al., and assigned to 3M, describes a pavement marking article having a monolayer of exposed-lens optical elements, a reflective layer, and a spacing layer between the optical elements and the reflective layer. The average thickness of the spacing layer relative to the average radius of the optical elements is selected such that when wet the article has a coefficient of retroreflection, RA, greater than 3.1 Cd/LX/M2.

U.S. Pat. No. 6,365,262, to Hedblom, et. al., and assigned to 3M, describes a pavement marking article having a monolayer of optical elements with an exposed-lens surface portion and an embedded-lens surface portion, a spacing layer in which the optical elements are partially embedded with the average thickness of the spacing layer relative to the average radius of the optical elements. The article has greater wet retroreflectivity than an article made without the spacing layer, a coefficient of retroreflective luminance, RL, of at least about 150 mCd/m2/Lx during rainfall and a reflective layer next to the spacing layer.

U.S. Pat. No. 5,777,791, to Hedblom, et. al., and assigned to 3M, describes a retroreflective pavement marker having a base sheet having a front surface and a back surface and a plurality of protrusions projecting from the front surface of the base sheet. Each of the protrusions has a top surface and at least one side surface connecting the top surface to the front surface of the base sheet. Additionally a binder layer having particles of specular reflector pigment covering a portion of the protrusions and partially embedded in the binder layer, of a plurality of Type A microspheres and a plurality of Type B microspheres, wherein at least 10 percent by weight of the total microspheres are Type A and at least 10 percent by weight of the total microspheres are Type B. The Type A microspheres have a different average refractive index than do the Type B microspheres and the Type B microspheres have an average refractive index of about 2.2 to about 2.3.

U.S. Pat. No. 6,703,108, to Bacon, et. al., and assigned to 3M, describes a retroreflective material having on a top surface thereof an enclosed-lens retroreflective sheet that comprises a cover layer, a monolayer of retroreflective elements and a specular reflector or an air interface protected by a sealing film. A first portion of the monolayer is arranged in an upwardly contoured profile and second portion of the monolayer arc arranged in a lower, substantially planar horizontal position. The material has a plurality of the first portions and a plurality of the second portions and wherein the material exhibits bright retroreflective performance under both wet and dry conditions such that the minimum retroreflective brightness of the material is at least 50 percent of the maximum retroreflective brightness of such material at any orientation angle at a constant entrance angle.

U.S. Pat. No. 6,841,223, to Rice, et. al., and assigned to 3M, describes a composite pavement marking having a marking length and a marking width transverse to the marking length. The marking width is defined by marking sides extending along the marking length, wherein the pavement marking further includes a bottom extending along the marking length and marking width, the pavement marking having a first portion width between first portion sides that is less than the marking width, a unitary retroreflective article attached to the first portion of the pavement marking, wherein a first portion height is defined by the distance between a top surface of the unitary retroreflective article and the bottom of the pavement marking, and wherein the unitary retroreflective article has a width that is substantially equal to the first portion width; and a second portion surrounding the first portion on at least two opposing sides, wherein the second portion comprises a second portion height above the bottom of the pavement marking that is different than the first portion height.

Chinese Publication No. CN1099832A, to Bollag, Moses, and assigned to Plastiroute, S. A., describes a reflecting body made of transparent material has coated paint speckles so provided on its surface that the light ray can enter the reflecting body and its intensity is sufficient to produce a reversal reflection and thus a light ray is ejected from the reflecting body. For the sake of controlling traffic in nighttime and moist day, it is placed on the laid pavement of a road or on the traffic borne road surface or on the plane marking line or on the traffic control road surface.

European Publication No. EP0385746B1, to Kobayashi, et. al., and assigned to Atom Chemical Paint Co. Ltd., describes a high-brightness all-weather type pavement marking sheet material having a reflex-reflecting sheet with a layer of glass microspheres of a relatively large diameter which are at least partially exposed in air and bonded to one another by a transparent resin. The reflecting layer consisting of a metallized film provided behind the transparent resin layer and a base sheet bonded to the lower surface of the reflex-reflecting sheet, characterized in that a layer of glass microspheres of a relatively small diameter are buried and fixed in a transparent resin layer between the layer of glass microspheres of a relatively large diameter and the reflecting layer, there being an interval between the glass microspheres of a large diameter and the glass microspheres of a small diameter and in that the base sheet is made of rubber of synthetic resin.

European Publication No. EP0237315A3, to Ishihara, et. al., and assigned to SEIBU POLYMER KASEI KABUSHIKI KAISHA, describes an all-weather type pavement marking sheet material having a base sheet made of rubber, synthetic resin or the like and glass microspheres having refractive index of 1.5-1.9 and glass microspheres having refractive index of 2.0-2.4 embedded mixedly and at least partially in a portion of the base sheet. The portion is formed at intervals in the longitudinal direction of the base sheet or continuously in the longitudinal direction of the base sheet in a part of the base sheet as viewed in the transverse direction of the base sheet.

Japanese Publication No. JP09228328A2, to Nakajima, et. al., and assigned to Sekisui Jushi Co. Ltd., describes a light reflective fine particle and a flowing resin that are injected to a die having a dent in the lower part, and the light reflective fine particle is settled in the flowing resin, or the flowing resin is injected after the light reflective fine particle is filled in the dent followed by hardening creating a road surface marker in which the light reflective fine particle is collected to the surface. A protruding part Y is manufactured by integral molding of a synthetic resin. After the resin is hardened, when a flowing resin layer of the same kind containing a fiber is superposed followed by hardening, a reinforcing layer can be formed on the reverse side. The marker has the protruding part Y on a lengthy tape X having a thickness T of 0.5-10 mm and a width of 50-500 mm, and the protruding part Y has a height D of 3-10 mm and a length L of 20-300 mm. Thus, the protruding part Y is protruded from the rainwater surface even in a rainy night, and a sufficient reflectivity can be ensured.

Canadian Publication No. CA2033527C, to Dinitz, Arthur, and unassigned, describes a safety roadway delineator including one or more elongate recessed marker surfaces which are coated with a reflective material, preferably a retroreflective material such as reflective glass beads. The recessed marker surfaces are vertical or at least inclined to the horizontal to insure water run-off and are formed either directly in cast-in-place concrete roadway members or in pre-cast polymer concrete facing panels which are attached to the cast-in-place concrete roadway members. The roadway delineator is substantially continuously protected from normal wear and reliably exhibits reflectivity both under dry and rainy weather conditions.

### SUMMARY OF THE DISCLOSURE

Disclosed is a profiled preformed thermoplastic pavement marking material and product with improved visibility in wet night conditions having a base layer of preformed thermoplastic material with a specified melting temperature in the range of 90° to 120° C. and a surface layer of thermoplastic material with raised profiles that have a specified melt temperature of 140° C.-150° C. The surface layer may contain one or more profiles with embedded reflective elements.

In another embodiment the raised profiles have a melting temperature of 20° to 30° C. higher or at least 10° C. higher than melting temperature of the base layer.

In another embodiment the raised profiles of the preformed thermoplastic pavement markings have a height of 2-10 mm (0.08-0.40 inches).

In another embodiment the higher melting temperature raised profiles are extruded at the same time as the base layer resulting in a single extruded preformed thermoplastic pavement marking and a strong adherence of the raised profile to the base layer.

In another embodiment the difference in melting temperatures between base layer and raised profiles provides strong adhesion of base layer to the pavement at the time of application while controlling the shape of the profiles and allowing for intermixing and embedding reflective elements such as drop-on glass beads or microspheres.

In another embodiment the intermixed reflective elements include glass beads with refractive index of 1.5 to 1.7 that correspond, for instance, to AASHTO M-247-81L standard and can be of different types with corresponding beads' sizes such as: T1: 150 to 850 um, T2: 150-1000 um, T3: 710-1400 mm, T4: 850-1700+ um, T5 1000-2000+ um and also other larger sizes and/or their blends.

In another embodiment the intermixed beads are high index glass beads with refractive index of 1.9 (BaO, SiO₂, TiO₂) to 2.0-2.4 (BaO, ZnO, TiO₂) wherein sizes range from 20 to 650 microns and higher. Beads are available from many suppliers, for instance from Swarco under the trade name “9plus”.

In another embodiment the intermixed beads are ceramic microspheres consisting of zirconia-silica with refractive index 1.75 or zirconia-alumina-silica with refractive index of 1.91. (described in U.S. Pat. Nos. 4,564,556 and 4,772,511 respectfully and incorporated here by reference)

In another embodiment the surface embedded drop on reflective elements may be applied during production or during installation to the selected pavement; reflective elements may be of sizes, shapes, compositions and refractive indices that include the same properties as the intermixed reflective elements described above, and in addition can include composite ceramic materials with high refractive index such as plus9spots® (available from Swarco) or microcrystalline ceramic optical elements (available from 3M) that can be used as singular items or in combination with other reflective materials.

In another embodiment the drop-on (surface embedded) elements may be friction-enhancing materials such as crushed glass, corundum, sand or other stone material.

In another embodiment the raised profiles and the base layer are melted together to form a monolithic material thus capable of application by using a flame torch or other heating means as known in the art to apply the PTPM directly to the pavement in a single step.

In another embodiment the raised profiles may be of various heights, in a specific pattern such as a grid, honeycomb, longitudinal line, transverse line, or diagonal lines and may include different shapes such as round, square, elongated, droplet shaped, polygon or other designs that convey a direction or pattern while also allowing for water to run off the raised surface, thereby providing for better reflectivity and visibility in wet/rainy and/or nighttime conditions.

In another embodiment the preformed thermoplastic pavement marking material may be formed in complex shapes denoting turn lines, signage and in-lane markings and/or including raised profiles of various heights or patterns.

In another embodiment the preformed thermoplastic pavement marking material may be adhered to the pavement with or without pre-heating of the pavement.

Additionally an embodiment of the disclosure is to provide controlled heating and shaping of the profiles and embodiment of reflective elements by using indent markings.

An additional embodiment is that the base layer may contain a non-woven net or a woven net having fibers with melting temperatures higher than 220° C.

### DETAILED DESCRIPTION

Presently the pavement marking industry employs linear materials with multilayered construction applied by pressure sensitive adhesive (PSA) or direct imprint sprayed on paints for high traffic areas which are not durable and, in the case of sprayed on markings, are limited in thickness and design.

What is disclosed is a preformed thermoplastic pavement marking (PTPM) material that is a single layered dual composition profiled pavement marking that can be made into desired shapes that communicate information to a driver of a vehicle. Additionally, reflective or retroflective elements are added and desired profiles are created that shed water, thereby maintaining the retroreflectivity in rainy and/or wet environments and maintaining consistent reflectivity as the vehicle distance from the reflective element changes. Differences in the dual composition melt temperatures result in strong adherence of the lower melt temperature layer to the pavement surface. When adherence is performed at the same time, the higher melt temperature layer provides control of the shape of the profiles and allows for optional embedding of drop-on reflective/retroflective elements.

The application of the PTPM is performed by heating to a desired temperature causing the first composition to melt onto and into the pavement surface. Optionally, the pavement may be preheated prior to application of the PTPM.

The design allows control of various profile heights, creation of different shapes and patterns of placing of profiles on the base and is more durable where there is high traffic contact. The base layer is at least 1.0-3.5 mm thick, preferably 2 mm thick, providing sufficient mechanical strength to the material

The extruded preformed thermoplastic pavement marking is a low melt first composition thermoplastic material used for the base material and a higher melt second composition thermoplastic material is used for desired profiles. The thermoplastic materials are extruded together in the pattern that is desired in the pavement marking. Low melt first material composition is generally in the 90° C.-120° C. melt temperature range. The second composition is a relatively higher melt thermoplastic material used in the profile and is +10° C. to +30° C. higher than the melt temperature of the selected first composition material. It is possible that the second composition is in a range of +10° C. to +70° C. or higher with a preferable melting temperature range of at least +30° C. over the selected first composition base material. All melt temperatures are measured by standard ring & ball methods.

Additionally, the first composition material may have an intermixed percentage of glass beads (or reflective/retroflective elements) which provides a lower content than that of the second (top) composition content of the profile thermoplastic material. When applied to a pavement and over time, the surface exposed to traffic begins to wear. The surface reflective/retroflective elements also wear, but the intermixed reflective elements of the profile material continue to exhibit reflective properties enabling a longer functional life and longer reliability.

Hydrocarbon and alkyd based resin can be used for base and profiled material. Materials contain a thermoplastic binder together with glass beads, pigments, fillers and rheology modifiers. Binders can include polymers, tackifiers, plasticizers and/or waxes.

### EXAMPLE I

An example of the dual component hydrocarbon resin composition is provided as:

Base composition:

| | |
|---|---|
| Escorez 1310L | 8%, |
| C5 hydrocarbon resin - | 3% |
| Refined mineral oil - | 3%, |
| Escorene EVA MV 7710 | 4% |
| Titanium dioxide (Rutile) - | 10% |
| Glass beads T1 - | 22% |
| CaCO3 - | 28% |
| Sand - | 22% |

Material has softening temperature as measured by R&B 96° C.

Profile material composition

| | |
|---|---|
| Escorez 1315 - | 10% |
| C5 hydrocarbon resin - | 5% |
| Refined mineral oil - | 2% |
| Escorene EVA MV 02514 | 3% |
| Fumed silica - | 0.5% |
| Titanium dioxide (Rutile) - | 10% |
| Glass beads T1 - | 20% |
| Sand - | 19.5% |

Material has softening temperature as measured by R&B 116° C.

### EXAMPLE II

Another example, this including a dual component alkyd resin composition is provided as:

Example of Alkyd Composition

Base material

| | |
|---|---|
| Polyamide resin Unirez 2651 (Arizona Chemical) | 7.5% |
| Maleic modified rosin resin Sylvacote 4973 - | 8.0% |
| Phthalate Plasticizer | 4.0% |
| PE based wax | 2.0% |
| Fumed silica | 0.5% |
| Glass beads AASTO M247 T1 - | 30% |
| TiO2 - | 10% |
| CaCO3 - | 38% |

Material softening temperature is 106° C.

Profile material

| | |
|---|---|
| Polyamide resin Unirez 2294 - | 4% |
| Polyamide resin Unirez 2628 - | 3% |
| Maleic modified rosin resin Sylvacote 7003 - | 7% |
| Phthalate plasticizer - | 3% |
| PE based wax - | 2.0% |
| Fumed silica - | 0.3% |
| Glass beads T1 - | 20% |
| Glass beads T4 - | 30% |
| TiO2 - | 10% |
| CaCO3 - | 20.7% |

Material softening temperature (R&B) is 159° C.

It should be understood that although examples are given it should not be construed that these are given only as examples and that variations of the invention are possible while adhering to the inventive concept herein disclosed.

1. A preformed thermoplastic pavement marking (PTPM) comprising: a single layer dual composition including a first composition with a lower melt temperature than the second composition, wherein said second composition provides one or more desired profiles, said dual composition comprising pavement marking that provides reflective and/or retroflective elements added to either said first composition or to said desired profiles or both, whereby said desired profiles shed water, thus maintaining reflectivity in rainy and/or wet environments.

2. The preformed thermoplastic pavement marking (PTPM) of claim 1, wherein the differences in said dual composition melting temperatures of said first composition and said second composition results in strong adherence of said first composition to a pavement surface and said second composition allows for control of the shape of said desired profiles and also allows for optionally dropping-on and surface embedding of said reflective elements.

3. The preformed thermoplastic pavement marking (PTPM) of claim 1, wherein said first composition has a melt temperature generally in the range of 90° C. to 120° C.

4. The preformed thermoplastic pavement marking (PTPM) of claim 1, wherein a melt temperature of said second composition is generally in the range of 10° C. to 70° C. higher and most preferably 30° C. higher in melt temperature than said first composition.

5. The preformed thermoplastic pavement marking (PTPM) of claim 1, wherein said first composition is at least 1.0-3.5 millimeters thick, preferably 2 millimeters thick.

6. The preformed thermoplastic pavement marking (PTPM) of claim 1, wherein said desired profiles have a height in the range of 2-10 millimeters.

7. The preformed thermoplastic pavement marking (PTPM) of claim 1, wherein various heights, shapes, patterns, and placements of said desired profiles is allowable before, during and after installation of said PTPM.

8. The preformed thermoplastic pavement marking (PTPM) of claim 1, wherein said first composition has an intermixed percentage of said reflective elements which is a lower in percentage than that of said second composition and wherein said reflective elements may be of different sizes and shapes throughout said dual composition.

9. The preformed thermoplastic pavement marking (PTPM) of claim 1, wherein said preformed thermoplastic pavement marking comprises hydrocarbon and/or alkyd based resins.

10. The preformed thermoplastic pavement marking (PTPM) of claim 1, wherein said reflective elements include glass beads with refractive index of 1.5 to 1.7, that meet AASHTO M-247-81L standard from Type 1 to Type 5 and larger, high index glass beads with refractive index of 1.9 to 2.4, high index ceramic microspheres and/or are high index glass beads or metal oxides with a refractive index in the range of 1.9 to 2.4 wherein sizes of said metal oxide particles range from 20 to 650 micron.

11. The preformed thermoplastic pavement marking (PTPM) of claim 10, wherein said metal oxide particles include oxides of barium, silicon, zinc, titanium.

12. The preformed thermoplastic pavement marking (PTPM) of claim 1, wherein said reflective elements are ceramic microspheres comprising zirconia-silica or zirconia-alumina-silica.

13. The preformed thermoplastic pavement marking (PTPM) of claim 1, wherein said reflective elements can be applied during production or during installation to the selected pavement and include various sizes, shapes, compositions and refractive indexes.

14. The preformed thermoplastic pavement marking (PTPM) of claim 1, wherein said reflective elements are surface embedded and exhibit retroflective or reflective properties equivalent to intermixed reflective elements, composite ceramic elements, microcrystalline ceramic optical elements and their blends.

15. The preformed thermoplastic pavement marking (PTPM) of claim 14, wherein said surface embedding of said reflective elements is with or without crushed glass, corundum, sand or other stone material provide friction enhancing properties.

16. The preformed thermoplastic pavement marking (PTPM) of claim 1, wherein installation of said preformed thermoplastic pavement marking is accomplished using a flame torch and/or a heating means as known in the art in a single step so that the pavement may be heated directly to ensure said PTPM is properly and completely adhered.

17. The preformed thermoplastic pavement marking (PTPM) of claim 1, wherein said desired profiles are provided with a specific pattern such as a grid, honeycomb, longitudinal line, transverse line, or diagonal lines and also said profiles can be provided with different shapes including; round, square, elongated, droplet shaped, polygon or other designs that conveys a direction or pattern and provide a path for water to run off said desired profiles thereby providing reflectivity and visibility of said profile in wet and/or rainy and/or nighttime conditions.

18. The preformed thermoplastic pavement marking (PTPM) of claim 1, wherein said preformed thermoplastic pavement marking is formed in complex shapes denoting turn lines, signage and in-lane markings and/or with said desired profiles of various heights or patterns.

19. The preformed thermoplastic pavement marking (PTPM) of claim 1, wherein said first composition contains a non-woven or woven net having fibers with melting temperatures higher than 220° C.

20. The preformed thermoplastic pavement marking (PTPM) of claim 1, wherein overheating of said second composition during installation is prevented by indent marking indicating sufficient heating.
